(19) United States
(12) Patent Application Publication
(10) Pub. No.: US 2004/0204163 A1
(43) Pub. Date: Oct. 14, 2004

(54) Modular Modification of cellular phone handfree kit and the applications thereof

(76) Inventor: Jack Ou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/246,471

(22) Filed: Sep. 19, 2002

(51) Int. Cl. H04B 1/38; H04M 1/00

(52) U.S. Cl. 455/569.1; 455/90.1; 455/575.1

(57) ABSTRACT

The present invention discloses a modular modification of cellular phone handfree kit and the applications thereof, wherein said cellular phone handfree kit comprising a front cap, a back cap, a clasp and an upholder portion; said cellular phone handfree kit is suitable for use with different folding-type cellular phones by exchanging said clasp and said upholder portion; said cellular phone handfree kit further comprising a circuit board which comprises a FM audio signal module and a charging controller, said FM audio signal module further comprising a signal amplifying circuit, a FM modulation module, a filter and a transmitting antenna; upon receiving an audio signal from a cellular phone, said cellular phone handfree kit processing and converting said audio signal to a FM audio signal, transmitting said FM audio signal to a radio or a FM receiver using said transmitting antenna, and broadcasting said FM audio signal using a speaker of said radio or said FM receiver.

### BACKGROUND OF THE INVENTION

1. Field of the Invention

The present invention relates to cellular phone handfree kit, and more particularly, to a modular modification of cellular phone handfree kit suitable for folding-type cellular phones having large displays, wherein the cellular phone handfree kit converting audio signal into FM audio signal for wireless transmission.

2. Description of the Prior Art

The structure of traditional cellular phone handfree kit consists of a front cap and a back cap combining together as the body, a clasp sitting on both sides of the body to clip and fasten the cellular phone. However, these cellular phone handfree kits currently in the market are for full-length, non-folding-type cellular phones, thus not suitable for folding-type cellular phones.

The U.S. patent application Ser. No. 6,304,764 describes FM audio converting and transmission techniques for cellular phone handfree kit. The circuits for FM audio converting and transmission techniques are designed into the motherboard inside the cellular phone handfree kit, therefore the circuits are not replaceable in accordance with user's need. Besides, the circuits are complicated to design due to signal processing requirements.

For reference of prior art of the modular modification of cellular phone handfree kit, please refer to the U.S. patent application Ser. No. 558,849, and U.S. Pat. Ser. No. 6,381,338, Ser. No. 6,359,995 from the same inventor of the present invention. The U.S. patent application Ser. No. 558,849 describes a modified structure of cellular phone handfree kit having a base to place cellular phone, a clip on the base to firmly fasten the cellular phone onto the base, and a connector on the base for connecting the cellular phone and broadcasting voice call through speaker. Besides, a resonating device is located outside the speaker to provide rich, clear and focusing sound to facilitate easy, unimpeded conversation between the driver and the caller. A switch button is located on the base to selectively control the sound outputting from speaker or earphone.

The U.S. Pat. Ser. No. 6,381,338 entitled “All directionally turnable radio microphone” describes the structure of a radio microphone which can rotate in all directions. User can use this rotary structure to adjust the radio microphone to its best reception angle and place the transmitter and receiver separately using wireless transmission techniques for non-interfering communication. The rotary structure can effectively prevent the noise resulted from the cross-interference, therefore optimizing the quality of the voice communication.

The U.S. patent application Ser. No. 6,359,995 describes the structure of an wireless earphone fittable to both ears by hanging. The cited earphone can be fitted to left or right ear according to user's habit or sense of comfort.

By using the above-mentioned skills with the present invention, the capability of the cellular phone handfree kit is greatly improved. Besides, the receiver and transmitter can communicate with each other using wireless transmission techniques.

In view of the above-described imperfections of the traditional devices, after years of constant effort in research, the inventor of this invention has consequently developed and proposed the modification of cellular phone handfree kit and the applications thereof.

### SUMMARY OF THE INVENTION

The object of the present invention is to provide a modular modification of cellular phone handfree kit and its applications suitable for use with different brands and models of folding-type cellular phones by changing the modules of the clasp and the upholder portion.

It is another object of the present invention to provide a modification of cellular phone handfree kit and its application suitable for use with common cellular phone handfree kit to enhance the capability by delivering the voice signal via the speaker of radio or FM receiver.

It is still another object of the present invention to provide a modular modification of cellular phone handfree kit using low power mode (e.g., lower than 1 mW) to transmit FM audio signal directly to radio or FM receiver.

The present invention discloses a modular modification of cellular phone handfree kit comprising at least a front cap, a back cap, a clasp and an upholder portion. The present invention is suitable for different types or brands of folding-type cellular phone by exchanging the modules of clasp and upholder portion. The circuit board of the present invention comprises a FM audio signal module and a charging controller. The FM audio signal module comprises a signal amplifying circuit, a FM modulation module, a filter and a transmitting antenna. Upon receiving the audio signal from the cellular phone, the cellular phone handfree kit transmits the audio signal to signal amplifier for signal amplification, then FM modulation module modulates the audio signal into FM audio signal, which is processed by filter to remove unwanted noise in the FM audio signal. The transmitting antenna transmits the FM audio signal to radio or FM receiver using low power mode, which is less than 1 mW, then the speaker of the radio or FM receiver is used to broadcast the received FM audio signal.

### BRIEF DESCRIPTION OF THE DRAWINGS

The drawings disclose an illustrative embodiment of the present invention which serves to exemplify the various advantages and objects hereof, and are as follows:

FIG. 1 is a block diagram of FM audio transmission module of a modular modification of cellular phone handfree kit described in the present invention;

FIG. 2 is a block diagram of the FM audio transmission module and charging controller used in the cellular phone handfree kit;

FIGS. 3(a) and (b) is an example of the modular modification of cellular phone handfree kit of the present invention;

FIG. 4 is an example of the modular modification of cellular phone handfree kit of the present invention and other wireless transmission devices;

FIG. 5(a) is an exploded view of the modular modification of cellular phone handfree kit of the present invention; and

FIG. 5(b) is an assembled view of the modular modification of cellular phone handfree kit of the present invention.

### DETAILED DESCRIPTION OF THE PREFERRED EMBODIMENT

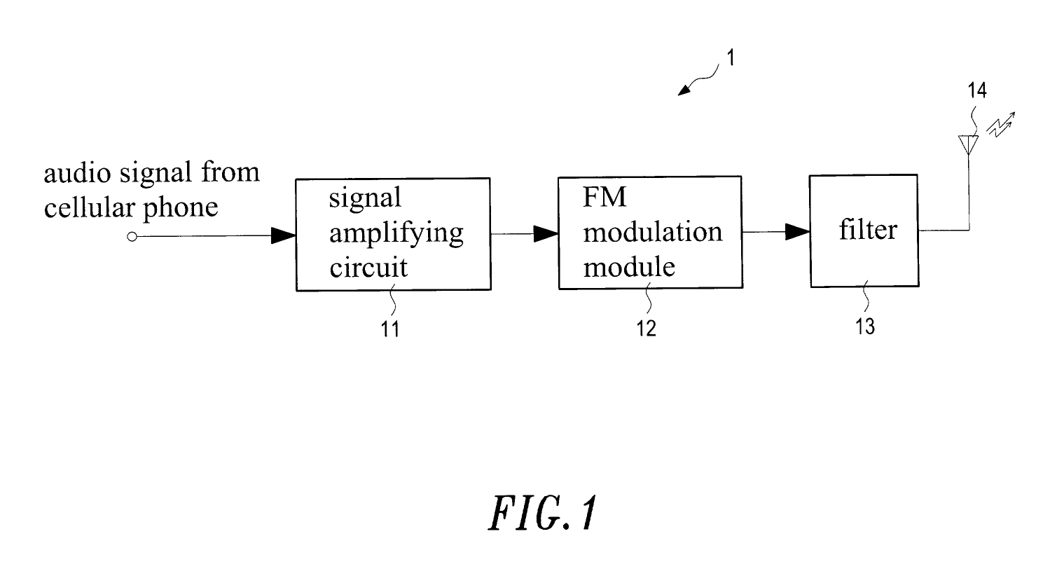

Please refer to FIG. 1 for the modular modification of cellular phone handfree kit provided in the present invention. The FM audio transmission module 1 mainly comprises a signal amplifying circuit 11 `a FM modulation module 12 ` a filter 13 and a transmitting antenna 14. Upon receiving the audio signal from the cellular phone, the cellular phone handfree kit transmits the audio signal to signal amplifier 11 for signal amplification, then FM modulation module 12 modulates the audio signal into FM audio signal, which is processed by filter 13 to remove unwanted noise in the FM audio signal. The transmitting antenna 14 transmits the FM audio signal to radio or FM receiver using low power mode, which is less than 1 mW, then the speaker of the radio or FM receiver is used to broadcast the received FM audio signal.

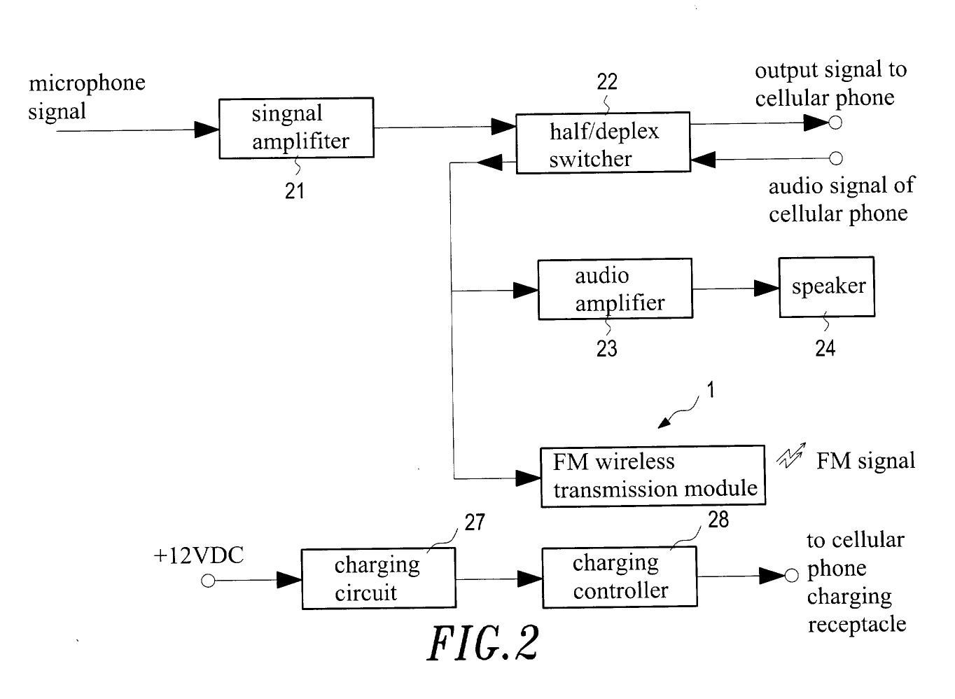

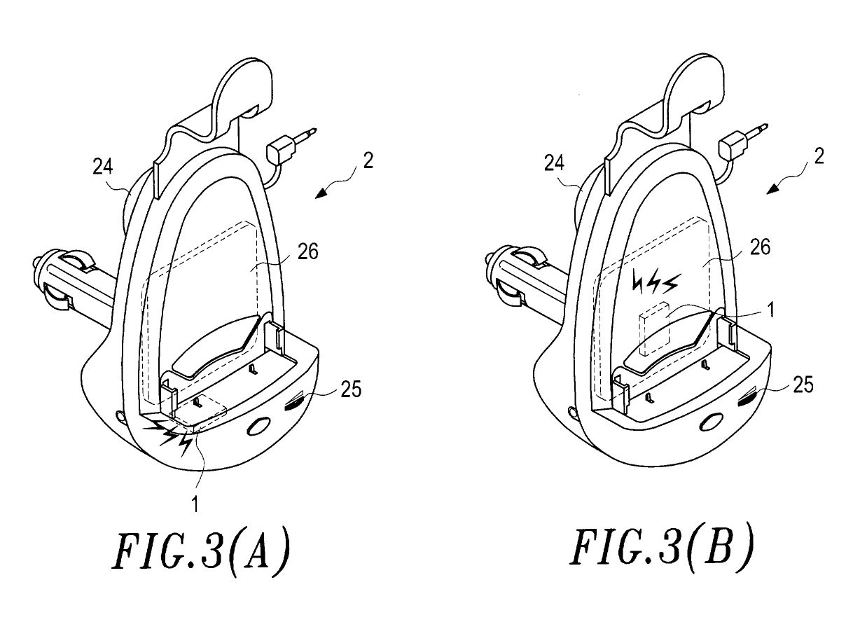

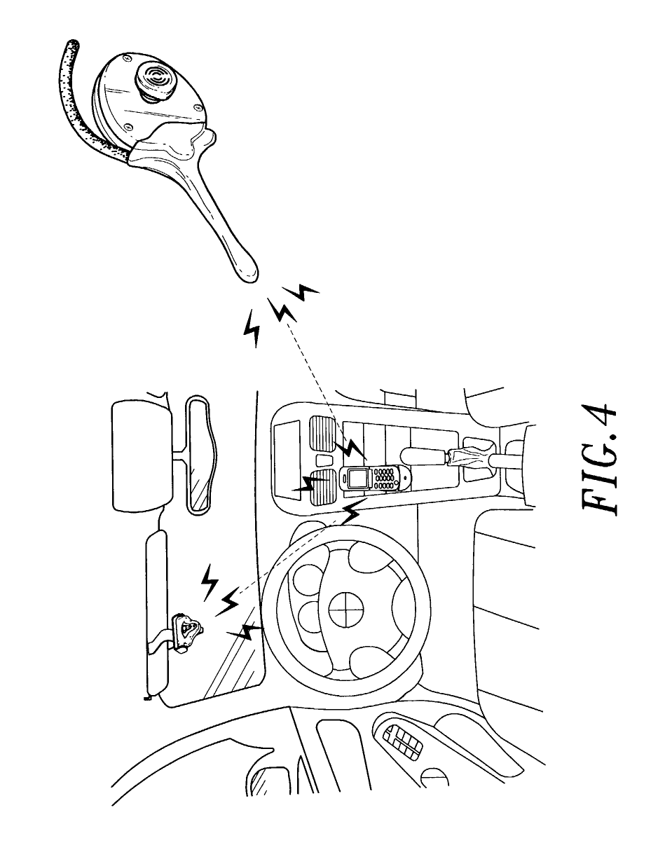

Please Refer to FIGS. 2, 3(a), 3(b) and 4 simultaneously for the block diagram and illustrations of the preferred embodiment of the present invention. Cellular phone handfree kit 2 receives the microphone signal and the audio signal, the microphone signal is amplified by signal amplifier 21, the amplified microphone signal and the audio signal are fed into half-/duplex switcher 22 for processing. The processed signal from half-/duplex switcher 22 is amplified by audio amplifier 23 and broadcast by speaker 24, wherein the output volume of speaker 24 is controlled by volume controller 25. When a FM audio transmission module 1 disclosed in the present invention is inserted into cellular phone handfree kit 2, the signal from half-/duplex switcher 22 is also converted to FM audio signal by FM audio transmission module 1 and then transmitted to car radio or FM receiver for broadcasting. A charging controller 28 selectively controls and couples the charging circuit to the cellular phone for charge. An LED located on the charging controller 28 is used to indicate the charging status of the cellular phone handfree kit by the color of LED. When the FM audio transmission module 1 is inserted into the cellular phone handfree kit, user can selectively choose to broadcast the sound from cellular phone handfree kit or car radio or wireless earphone. Furthermore, due to the modular structure of the present invention, the FM audio transmission module 1 for wireless transmission described in the present invention can be implemented solely in the cellular phone handfree kit to enhance the capability of the cellular phone handfree kit. Or the manufacturer can reserve a space for the FM audio transmission module 1 on the circuit board 26 inside the cellular phone handfree kit and selectively add the FM audio transmission module 1 onto the circuit board 26 inside the cellular phone handfree kit in accordance with user's requirement to enhance the capability of FM audio transmission.

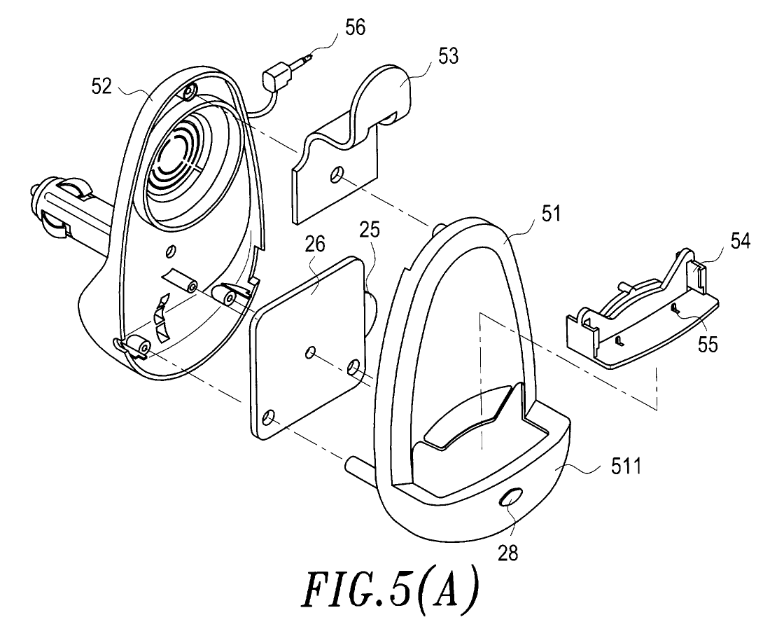

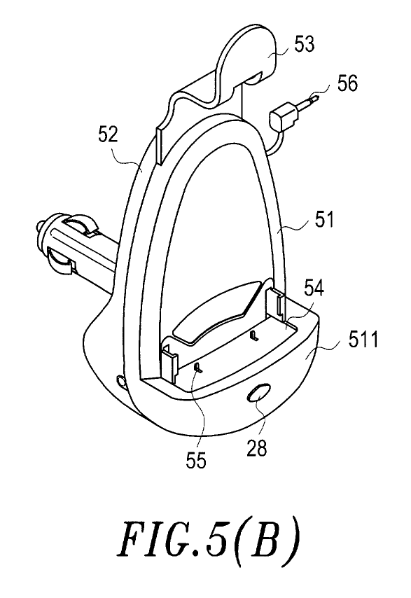

Please refer to FIGS. 5(a) and 5(b) simultaneously for an exploded view and an assembled view of a modular modification of cellular phone handfree kit of the present invention, wherein the present invention comprises a front cap 51, a back cap 52, a circuit board 26, a clasp 53 and an upholder portion 54. Front cap 51 comprises a through hole on top to place clasp 53 and a base 511 with another through hole for placing upholder portion 54. A conductor 55 for charging the cellular phone is implemented on the upholder portion 54 or clasp 53 and controlled by charging controller 28 in base 511 to selectively couples the cellular phone to a power source. Back cap 52 comprises a volume controller 25 and a hole for audio plug 56 for receiving audio signal from the cellular phone. Audio plug 56 is suitably extended from a location on the back cap 52 to plug into the receptacle on either side of the cellular phone. Circuit board 26 is suitably placed between front cap 51 and back cap 52 of the cellular phone handfree kit, wherein clasp 53, upholder portion 54, volume controller 28 and audio plug 56 are also fasten by front cap 51 and back cap 52. The present invention is suitable for any folding-type cellular phone by exchanging different modules of clasp 53 and upholder portion54.

The present invention discloses a modular modification of cellular phone handfree kit and the applications thereof, it is advantageous in,

1. The present invention provides a modular modification of cellular phone handfree kit and the applications thereof, it is suitable for different types or brands of folding-type cellular phones by exchanging the modules of clasp and upholder portion.

2. The present invention provides a modular modification of cellular phone handfree kit and the applications thereof, wherein the circuits for converting audio signal into FM signal is implemented in modular form.

3. The present invention provides a modular modification of cellular phone handfree kit and the applications thereof, wherein the present invention is implemented into common cellular phone handfree kit for broadcasting the audio signal via the speaker of radio or FM receiver to enhance the capability of cellular phone handfree kit.

4. The present invention provides a modular modification of cellular phone handfree kit and the applications thereof using low power mode (less than 1 mW) to transmit the audio signal directly to radio or FM receiver.

Many changes and modifications in the above-described embodiment of the invention can, of course, be carried out without departing from the scope thereof. Accordingly, to promote the progress in science and the useful arts, the invention is disclosed and intended to be limited only by the scope of the appended claims.

What is claimed is:

1. A cellular phone handfree kit suitable for use with different folding-type cellular phones by means of exchanging modules, comprising:
an upholder portion for supporting a cellular phone;
a clasp, along with the upholder portion, for fastening said cellular phone;
a front cap comprising a first through hole on top to place said clasp and a base with a second through hole for placing said upholder portion;
a back cap comprising a volume controller and a plug for receiving an audio signal from said cellular phone; and
a circuit board placing between said front cap and said back cap.

2. The cellular phone handfree kit as recited in claim 1, wherein said circuit board comprises a FM audio transmission module for converting said audio signal into a FM audio signal for transmission, comprising:
a signal amplifying circuit for receiving said audio signal from said cellular phone and generating an amplified signal;
a FM modulation module for modulating said amplified signal from said signal amplifying circuit into said FM audio signal and a noise;
a filter for removing said noise generated by said FM modulation module; and
a transmitting antenna for transmitting said FM audio signal from said filter.

3. The cellular phone handfree kit as recited in claim 1 further comprises a charging controller, said charging controller comprising a LED using a color for indicating a charging status of said cellular phone handfree kit.
